(19) United States
(12) Patent Application Publication
(10) Pub. No.: US 2007/0182258 A1
(43) Pub. Date: Aug. 9, 2007

(54) Electric motor for a drive of a vehicle, in particular railroad drives, and a drive having such an electric motor

(75) Inventors: Bernhard Klaussner, Nurnberg (DE); Gerhard Maul, Nurnberg (DE); Alexander Maurer, Nurnberg (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/563,525

(22) PCT Filed: Jun. 24, 2004
(86) PCT No.: PCT/EP04/06855

§ 371 Date: Jun. 12, 2006

(30) Foreign Application Priority Data
Jul. 1, 2003 (DE) 103 29 678.6

(51) Int. Cl. H02K 1/04; H02K 9/00; H02K 3/00

(52) U.S. Cl. 310/43; 310/179; 310/214; 310/215; 310/58; 310/217

(57) ABSTRACT

The invention relates to a drive unit for a vehicle and an electric motor that is suitable therefore, comprising a rotor and a stator (1) which is formed by a sheet metal pack (2) and is provided with grooves, at least one winding (3a) being disposed in said grooves (3). The electric motor is penetrated by cooling air. In order to keep production costs low and obtain thermal class 200, the winding (3a) is formed from round wires (7) that are provided with an insulation (12) while the coil heads (4) are embedded in a temperature-resistant elastic material (4a) so as to be protected against external influences.

### BACKGROUND OF THE INVENTION

The invention relates to an electric motor for a drive of a vehicle, in particular railroad drives, and a drive having such an electric motor.

Electric railroad drives are generally known. They have at least one electric motor as a drive motor which is formed from a rotor and a stator. The stator is composed of a laminated core with a bore in which grooves are formed distributed over its entire internal circumference. A winding which projects at one end out of the laminated core and forms the winding core of the winding is placed in the grooves. If the electric motor is ventilated by a through draft, the stator and rotor are cooled directly by cooling air. Cooling air flows around the stator winding here.

Such electric motors with ventilation by through draft have a high weight per unit power and are embodied as molded coil windings made of flat wire. Such electric motors may be manufactured for the thermal class 200, i.e. the motor may be operated with an excess temperature (temperature difference) of 200 Kelvin compared to the surrounding air.

The disadvantage of the known motors with molded coil windings made of flat wire is that they are relatively expensive to manufacture.

### SUMMARY OF THE INVENTION

The object of the invention is to propose an electric motor for a drive and a drive having such an electric motor which is more cost-effective to manufacture and satisfies the thermal class 200.

According to one aspect of the present invention, an electric motor for a drive of a vehicle, includes a rotor, and a stator which is formed from a laminated core and is provided with grooves in which at least one winding is arranged, with cooling air flowing through the electric motor, wherein the winding is formed from round wires which are provided with an insulation, and the winding heads are embedded in a temperature-resistant elastic material in order to protect them against external influences, with the result that the electric motor satisfies at least the requirements of thermal class 200. According to another aspect of the present invention, a drive, in particular for vehicles, includes an electric motor through which cooling air flows and which comprises a rotor and a stator which is formed from a laminated core and is provided with grooves in which at least one winding is arranged, wherein the winding is formed from round wires which are provided with an insulation, and the winding heads are embedded in a temperature-resistant elastic material in order to protect them against external influences, with the result that the electric motor satisfies at least the requirements of thermal class 200.

The solution provides, with respect to the electric motor, that the winding is formed from round wires which are provided with an insulation, and the winding heads are embedded in a temperature-resistant elastic material in order to protect them against external influences, with the result that the electric motor satisfies at least the requirements of thermal class 200. Cost savings are obtained with this electric motor from the use of coils made of round wires, but when this is the case it is absolutely necessary to embed the winding heads in a temperature-resistant elastic material in order, in particular, to satisfy the requirements of thermal class 200.

The temperature-resistant elastic material is advantageously a silicone rubber.

In order to improve the cooling there is provision for the cooling air to flow around the winding heads which are protected by the material.

In order to improve the cooling there is provision for the cooling air to flow through cooling bores provided in the stator.

Effective cooling of the electric motor is achieved if cooling air flows through the electric motor between the motor housing and the stator, which are connected to one another by means of webs.

In order to comply with thermal class 200 it is proposed that the grooves additionally have a groove side insulation formed from a material containing mica.

In order to comply with thermal class 200 it is proposed that the insulation of the round wires be composed of one or more high-temperature thermoplasts which are applied by extrusion.

It is cost-effective if the insulation of the round wires is composed of one or more layers of polyimide film.

The means of achieving the object provides, with respect to the drive, for the winding to be formed from round wires which are provided with an insulation, and the winding heads to be embedded in a temperature-resistant elastic material in order to protect them against external influences, with the result that the electric motor satisfies at least the requirements of thermal class 200.

### BRIEF DESCRIPTION OF THE DRAWING

The invention is described below with reference to a drawing, in which:

FIG. 1 shows the stator of the electric motor in a three-dimensional illustration with the viewing direction toward one end side,

FIG. 2 shows an enlarged illustration of a detail of the winding head according to FIG. 1, which is embedded in a temperature-resistant elastic material, and

FIG. 3 shows a cross section through a schematic illustration of a groove of the stator.

### DETAILED DESCRIPTION OF PREFERRED EMBODIMENTS

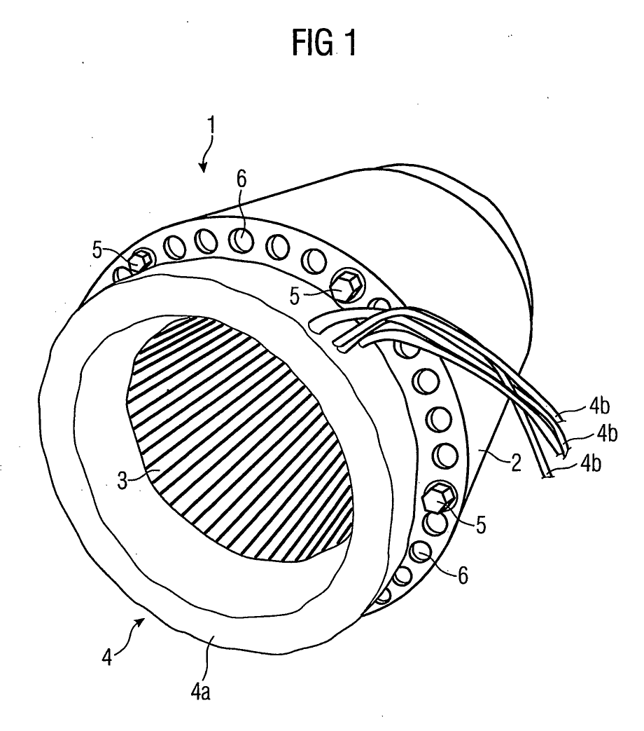

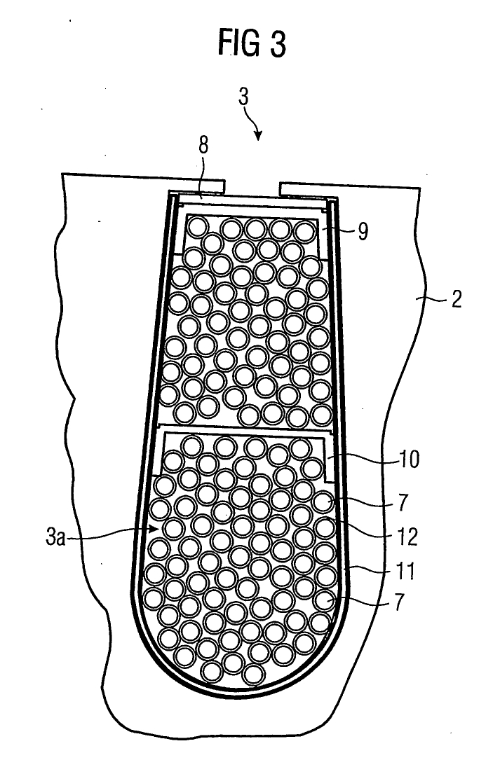

FIG. 1 shows a stator 1 of an electric motor for a railroad drive with the viewing direction toward the front end side. The stator 1 is usually embodied as a laminated core 2 in the form of a hollow cylinder which is provided on the inside with grooves 3 which are spaced apart equidistantly and extend in the direction of the longitudinal axis. A winding 3a (see also FIG. 3) whose winding heads 4 project out at the end from the laminated core 2 is arranged in the grooves. The winding head 4 is embedded in a temperature-resistant elastic material 4a in the form of silicone rubber in order to protect it against external influences. FIG. 1 also shows the connecting lines 4b of the winding 3a which are also embedded in silicone rubber. Furthermore, FIG. 1 shows screws 5 which can be used to prestress the laminated core. Furthermore, the end side of the laminated core shows the inlet openings of cooling bores 6 through which cooling air can flow.

When the electric motor is mounted, a rotor (not shown) is arranged in the stator, said rotor being rotationally mounted in the motor housing. Specifically, the laminated core 2 of the stator 1 can be connected to the motor housing by means of webs so that cooling air can flow through between the motor housing and the stator 1.

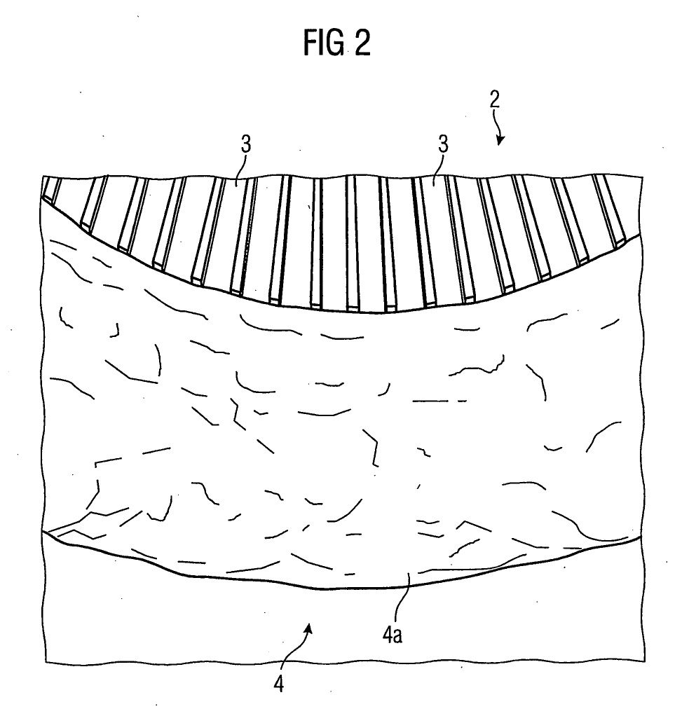

FIG. 2 is an enlarged illustration of a detail of the winding heads which are embedded in silicone rubber. In this context, the grooves 3 can be seen at the upper edge of the figure. As is shown by FIG. 2, the winding head is surrounded completely by silicone rubber which has been applied, for example, by dripping.

FIG. 3 shows a cross section through a groove 3 with an inserted winding 3a which is formed from round wires 7 here. The groove 3 which is made in the laminated core 2 is provided at the top with a groove closure strip 8 under which there is a cover slide 9 as a direct cover of the round wires. Approximately at half the depth of the groove there is also an intermediate slide 10 through which the upper layer and the lower layer of the winding are separated from one another in the two-layer winding which is implemented here. Furthermore, the groove 3 is provided on the inside with a groove side insulation 11. This has a material containing mica in order to provide the high resistance to temperature and thermal conductivity.

The round wires 7 of the winding are also provided with an insulation 12 which may be composed of a high-temperature thermoplast which is applied to the round wires by extrusion or else of one or more layers of polyimide film.

The electric motor of the railroad drive is used in such a way that the rotor and the stator have cooling air flowing through them when the vehicle is moving, i.e. generally when the vehicle is being propelled. Said cooling air also flows through the cooling bores 6 and, when the stator 1 is attached by means of webs to the motor housing, through the gap which is thus formed between the motor housing and stator 1.

This ensures that the electric motor and thus the drive satisfy the permissible operating conditions of thermal class 200.

1. (canceled)

2. The electric motor of claim 10, wherein the temperature-resistant elastic material is a silicone rubber.

3. The electric motor of claim 2, wherein the cooling system is configured to allow air to flow around the winding heads.

4. The electric motor claim 10, wherein the stator is constructed with cooling bores through which the cooling air flows.

5. The electric motor claim 10, further comprising a motor housing, said stator being connected to the motor housing by webs, with the cooling air flowing between the motor housing and the stator.

6. The electric motor claim 10, wherein the grooves are lined with a groove side insulation formed from a material containing mica.

7. The electric motor claim 10, wherein the insulation of the round wires includes at least one high-temperature thermoplast applied by extrusion.

8. The electric motor claim 10, wherein the insulation of the round wires includes at least one layer of polyimide film.

9. (canceled)

10. An electric motor for a drive of a vehicle, comprising:
a rotor;
a stator formed from a laminated core and provided with grooves for arrangement of at least one winding ending in winding heads; and
a cooling system for circulating cooling air through the electric motor,
wherein the winding is formed from round wires which are each embraced by an insulation, and the winding heads are embedded in a temperature-resistant elastic material for protection against external influences, so that the electric motor satisfies at least the requirements of thermal class 200.

11. A drive, in particular for a vehicle, comprising an electric motor which includes a rotor, a stator formed from a laminated core and provided with grooves for arrangement of at least one winding ending in winding heads, and a cooling system for circulating cooling air through the electric motor, wherein the winding is formed from round wires which are each embraced by an insulation, and the winding heads are embedded in a temperature-resistant elastic material for protection against external influences, so that the electric motor satisfies at least the requirements of thermal class 200.
